(19) United States
(12) Patent Application Publication
(10) Pub. No.: US 2026/0250092 A1
(43) Pub. Date: Aug. 27, 2026

(54) ALIGNMENT MODULE WITH AUTOMATIC PRESSURE CONTROL

(71) Applicant: BOBST MEX SA, Mex (CH)

(72) Inventors: Bryan CARDOSO, Pully (CH); David MANSOLINO, Apples (CH)

(73) Assignee: BOBST MEX SA, Mex (CH)

(21) Appl. No.: 18/874,877

(22) PCT Filed: Jun. 29, 2023
(86) PCT No.: PCT/EP2023/067801

§ 371 Date: Dec. 13, 2024

(30) Foreign Application Priority Data
Jun. 30, 2022 (EP) 22182308.1

(51) Int. Cl. B65H 7/02; B65H 9/16

(52) U.S. Cl. CPC B65H 7/02; B65H 9/163; B65H 2404/1532

(57) ABSTRACT

The present invention relates to an alignment module (11) for lateral alignment of blanks (2). The alignment module is configured to receive the blank between the upper pressing member (22) and a lower alignment conveyor (25) and convey the blank obliquely against a guide (26). The upper pressing member comprises a plurality of pressing rollers (42), comprising an upper pressing member (22) provided with a plurality of pressing rollers (42). At least some of the pressing rollers are connected to a respective actuator (54). The actuator is configured to displace the pressing roller (42) in the vertical direction, and wherein the alignment module further comprises a control unit (32) and a memory (34), wherein the control unit is configured to determine a required displacement for each pressing roller and actuate each respective actuator to perform the required displacement.

### FIELD OF THE INVENTION

The present invention relates to a converting machine for producing paper and cardboard containers, such as folding boxes. In particular, the invention relates to an alignment module configured to laterally align blanks before folding.

### BACKGROUND

Converting machines such as folder-gluers are used in the production of packaging items such as paperboard and cardboard boxes. These machines are configured to receive cut-to-shaped blanks and then fold and glue them together to form folding boxes or other similar packaging containers. The blanks are provided with cut lines which define the overall shape of the blank and crease lines which define the locations of folds.

In order to ensure that folding is effectuated at the location defined by the crease lines, the folder-gluer machine comprises an alignment module located upstream of a folding module. The alignment module is configured to laterally align the blanks. An example of an alignment module is described in document US7398872.

Depending on the material and thickness of the blanks, there is a need to adjust the contact pressure between an upper pressing member and an alignment conveyor in the alignment module. This is commonly done manually by the machine operator and by adjusting the vertical position of pressing rollers in the upper pressing member.

### SUMMARY

In view of the prior art, it is an object of the present invention to improve the accuracy of the contact pressure in an alignment module such that the blanks are grasped and accurately guided, while reducing the risk of damaging the blanks.

This object is solved by an alignment module according to claim 1.

According to a first aspect of the present invention, there is provided an alignment module for lateral alignment of blanks in a converting machine, the alignment module comprising a first alignment device comprising an upper pressing member provided with a plurality of pressing rollers, a lower alignment conveyor comprising a motorized alignment conveyor belt and a guide, wherein the alignment module is configured to receive the blank between the upper pressing member and the lower alignment conveyor and convey the blank against the guide, and wherein the upper pressing rollers are connected to a linear frame member and wherein at least some of the pressing rollers are connected to a respective actuator, said actuator being configured to displace the pressing roller in the vertical direction, and wherein the alignment module further comprises a control unit and a memory, wherein the control unit is configured to determine a required displacement for each pressing roller and actuate each respective actuator to perform the required displacement.

The invention is based on a realization that an automatic calculation and calibration of the vertical position of the pressing rollers against the blank allows for an individual and accurate pressure setting. This further allows for an adaptation to different formats, materials and blank thicknesses.

The upper pressing member and the lower alignment conveyor and preferably configured to convey the blank obliquely against the guide.

The contact pressure can be measured as force over area, i.e. in pascal units. In an embodiment, the contact pressure applied onto the blank can be between 0.5 to 3 bars.

The lateral alignment is in a direction perpendicular to the direction of transportation. The direction of transportation preferably extends from a feeder module to the alignment module, and further extends in a downstream direction to a folding module. The direction of transportation extends from the feeder module to a delivery module of the converting machine. The direction of transportation thus extends from an inlet to an outlet of the converting machine.

In an embodiment, wherein all pressing rollers are connected to a respective actuator and all pressing rollers are configured to be vertically displaced by each respective actuator.

The control unit may be configured to calculate a required contact pressure for each pressing roller and to displace the respective actuator to automatically perform the required displacement of each pressing roller.

In an embodiment, the control unit is configured to divide the pressing rollers into a first group and a second group, wherein the pressing rollers in each group are provided with the same displacement and the displacement is different for the first and second group.

In an embodiment, the pressing rollers in the first group are distanced away from the blank and the pressing rollers in the second group are applying a pressure against the blank.

In an embodiment, an inlet section is provided in an upstream part of the alignment module and wherein the pressing rollers in the inlet section are distanced away from the blanks such that they are not in contact with the blank, while the remaining pressing rollers are in contact with the blank. The pressing rollers in the guided section, which is located downstream of the inlet section, are thus in contact with the blank.

The control unit may be further configured to adjust the length of the inlet section by determining the longitudinal length of the blank in the direction of transportation and move the pressing rollers in the inlet section such that they are distanced away from the blank.

In an embodiment, a connection structure is arranged between the pressing rollers and the linear frame member, the connection structure comprises a plurality of cantilevered extensions and a pivot lever, wherein each pivot lever is interconnecting a pressing roller to the cantilevered extension.

In an embodiment, the connection structure further comprises a vertical extension to the cantilevered extension, and wherein the pivot lever has a first end connected to the vertical extension and a second end connected to the pressing roller, and wherein the actuator comprises a displacement rod connected to the pivot lever in a pivot point located on the pivot lever.

In an embodiment, wherein the cantilevered extensions extend in a direction perpendicular to the linear frame member.

In an embodiment, the actuator is a pneumatic actuator and is connected to a pneumatic circuit.

In an embodiment, each actuator is connected to a separate pneumatic circuit and wherein a central valve is configured to distribute the air supply to each pneumatic circuit.

In an embodiment, the control unit is configured to calculate the required displacement for the pressing rollers from the thickness (b1) of the blank. The control unit may further calculate the required displacement for the pressing rollers from the longitudinal length of the blank.

In an embodiment, the alignment module further comprises a second alignment device, and wherein the control unit is configured to deactivate one of the first and second alignment devices by moving all pressing rollers of the deactivated alignment device into a clearing position in which they are not in contact with the blank.

In an embodiment, an inlet section is provided in an upstream part of the alignment module and wherein the pressing rollers in the inlet section can be distanced away from the blanks.

In an embodiment, the control unit is further configured to adjust the length of the inlet section by determining the longitudinal length of the blank in the direction of transportation and move a number of rollers such that they are located at a vertical distance above the blanks.

In such a way, the pressing rollers are not touching the blanks. This allows the boxes exit the feeder before entering the alignment module and with alignment bar.

In an embodiment, the vertical position of the pressing roller can be adjusted from a control interface. This also allows for a second calibration of the contact pressure to be made from by the operator. The second calibration may be based on visual inspection and test runs.

In an embodiment, the memory is configured to store an inlet section length and a required displacement of the pressing rollers and make them retrievable from a user interface. These settings can be stored together with an identifier, and the control unit may be configured to automatically displace the pressing rollers when the control unit receives the identifier. The identifier can be a job code which is linked to predefined geometric characteristics of a blank. The geometric characteristics of the blank is preferably characterized by its longitudinal length and thickness.

### BRIEF DESCRIPTION OF THE DRAWINGS

The invention will now be described with reference to the appended drawings, in which like features are denoted with the same reference numbers and in which:

FIG. 1 is a schematic view of a converting machine in the configuration of a folder gluer;

FIGS. 2a and 2b are top views of a blank and a folding box, respectively;

FIG. 3 is a schematic perspective view of an alignment module as known in the prior art;

FIG. 4 is schematic cross-sectional side view of an alignment device from a first side and according to an embodiment of the present invention;

FIG. 5 is schematic cross-sectional side view of the alignment device of FIG. 4 from a second side;

FIG. 6a is a schematic perspective view of the alignment device of FIG. 4 and from a first side;

FIG. 6b is schematic perspective view of the alignment module of FIG. 4 and from a second side;

FIG. 7 is a schematic perspective view of a left and right alignment device; and

FIG. 8 is a detailed view of the upper pressing member in an alignment device according to an embodiment of the present invention.

### DETAILED DESCRIPTION

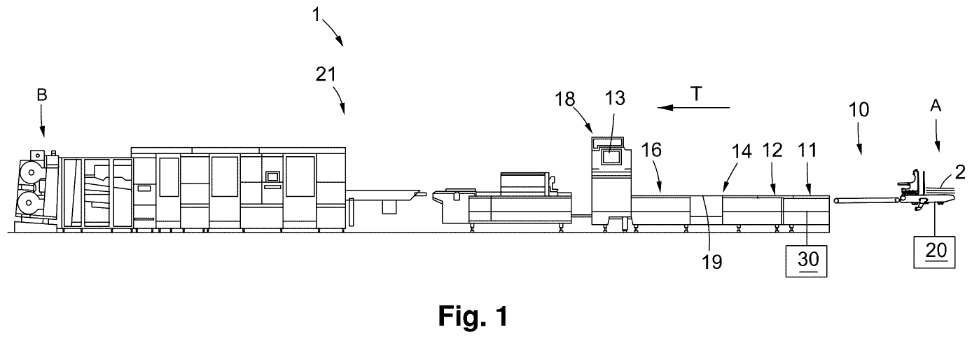

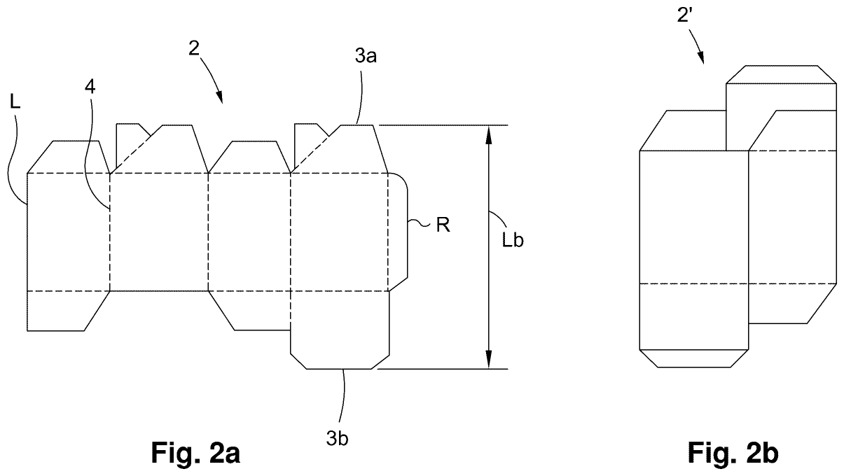

Referring to the figures and in particular to FIG. 1 which illustrates a converting machine 1 in the form of a folder-gluer machine 1, and FIGS. 2a and 2b which illustrate a blank 2 to be processed in the converting machine 1 and a folding box 2′. The folder-gluer machine 1 is configured to receive a cut to shaped blank 2 as the one illustrated in FIG. 2b, and then fold and glue the blank 2 to form a folding box 2′ or another folded and glued packaging container 2′. To enable folding, the blank 2 is provided with longitudinal crease lines 4 extending in the direction of transportation T of the blank 2.

The blank 2 has a longitudinal length Lb in the direction of transportation T. For blanks 2 with irregular front edges 3a and rear edges 3b, the longitudinal length Lb is the maximum length of the blank 2 in the direction of transportation T.

The present folder-gluer machine 1 comprises a series of different workstations in the form of modules. The modules may include, from an inlet A to an outlet B of the converting machine 1, and in a direction of transportation T: a feeder module 10, an alignment module 11, a fold pre-breaking module 12, a gluing module 14 and a folding module 16. The folder-gluer machine 1 may further comprise a main user interface 13 and a quality control system 18.

After the gluing and folding modules, a delivery module and conditioning section 21 can be provided in order to count and separate a shingled stream of folding boxes 2′ into separate batches.

The converting machine 1 further comprises a conveyance system 19 comprising conveyors such as endless belts and rollers configured to transport the blanks 2 in a direction of transportation T. The converting machine 1 also comprises a central control circuitry 20 configured to control the operation of the converting machine 1.

The alignment module 11 is arranged downstream in the direction of transportation T of the feeder unit 10 and is configured to laterally align the blank 2 to its predefined lateral position. The predetermined lateral position is defined by the position of the longitudinal crease lines 4 and the position of folding tools in the converting machine 1.

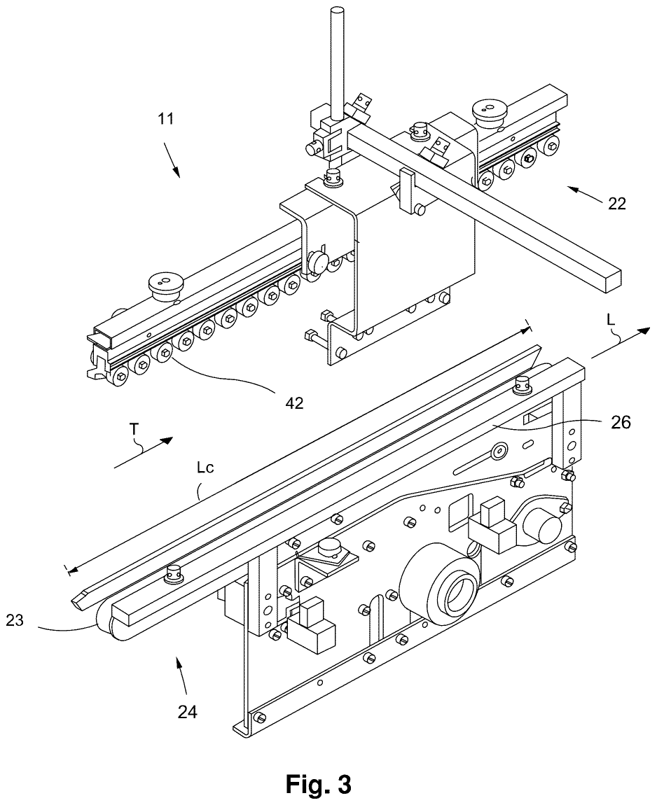

The alignment module 11 may be provided with a similar mechanical structure as the alignment module disclosed in U.S. Pat. No. 7,398,872 and as illustrated in FIG. 3. This mechanical structure comprises an upper pressing member 22 provided with a plurality of pressing rollers 42 arranged in a line, a lower alignment conveyor 24 and a guide 26. The upper pressing member 22 and the lower alignment conveyor 24 form an alignment device 25.

The alignment module 11 is configured to receive the blank 2 between the upper pressing member 22 and the alignment conveyor 24. The upper pressing member 22 and the alignment conveyor 24 are arranged at an angle in the direction of transportation T such as to direct a lateral edge L, R of the blanks 2 against the guide 26. The guide 26 is arranged with its longitudinal extension L coinciding with the direction of transportation T. The direction of transportation T is thus defined by the guide 26 in the alignment module 11.

The alignment conveyor 24 comprises an endless conveyor belt 23 having a contact length Lc configured to be in contact and drive the blank 2 forward in the direction of transportation T.

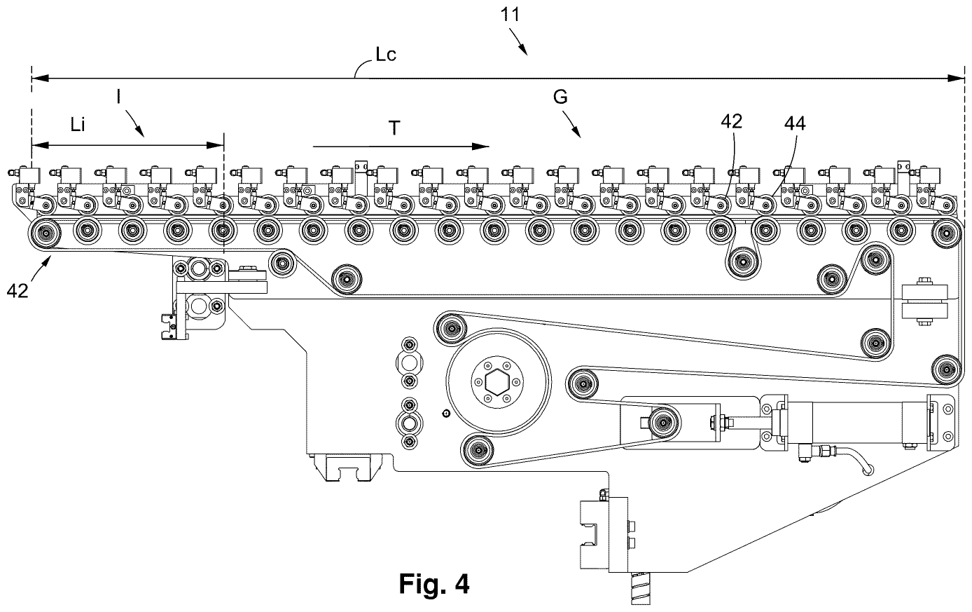

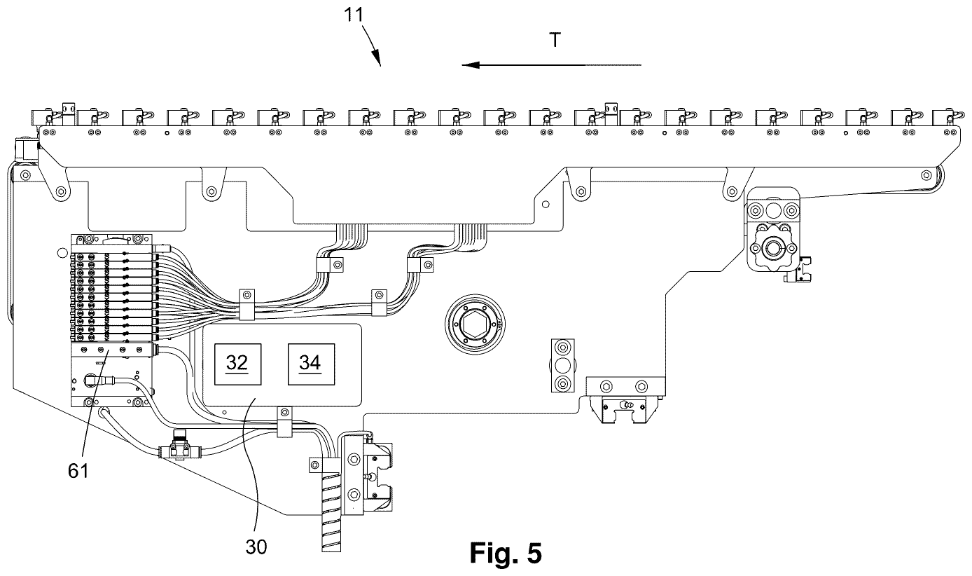

As illustrated in FIGS. 4 and 5, and according to the present invention, at least some of the pressing rollers 42 are connected to a respective actuator 54. Hence, a dedicated actuator 54 is connected to at least some of the pressing rollers 42. The actuators 54 are configured provide a vertical displacement to the pressing rollers 42 such that their contact pressure against the blank 2 can be set. In a preferred embodiment, each of the pressing rollers 42 in the alignment module 11 are displaceable by a respective actuator 54.

However, it is also possible to only arrange some of the pressing rollers to be displaceable by an actuator 54. In this embodiment, some pressing rollers 42 may be manually movable or fixedly positioned.

The alignment module 11 may further comprise an inlet section I. The inlet section I provides a distance Li over which the blanks 2 are not guided. This can be achieved by setting the contact pressure of the pressing rollers 42 in the inlet section I to be zero or at least lower than in a guided section G of the pressing member 22, such that the pressing member 22 does not change the trajectory of the blank 2 in the inlet section I. This allows the alignment module 11 to receive the full longitudinal length Lb of the blank 2 before urging the blank 2 sideways. This also allows the blanks 2 to exit from the feeder module 10 before modifying their trajectory. Optionally, some pressing rollers 42 in the inlet section I may be configured as either fixed or manually movable.

The length of the inlet section I can be configured such that the blank 2 will only be moved laterally when the entire longitudinal length Lb of the blank 2 is in the alignment module 11. The length Li of the inlet section may thus be selected to correspond to the longitudinal length Lb of the blank 2.

The alignment module 11 further comprises a control circuitry 30 comprising a control unit 32 and a memory 34. The control circuitry 30 may be connected to the central control circuitry 20 and the user interface 13.

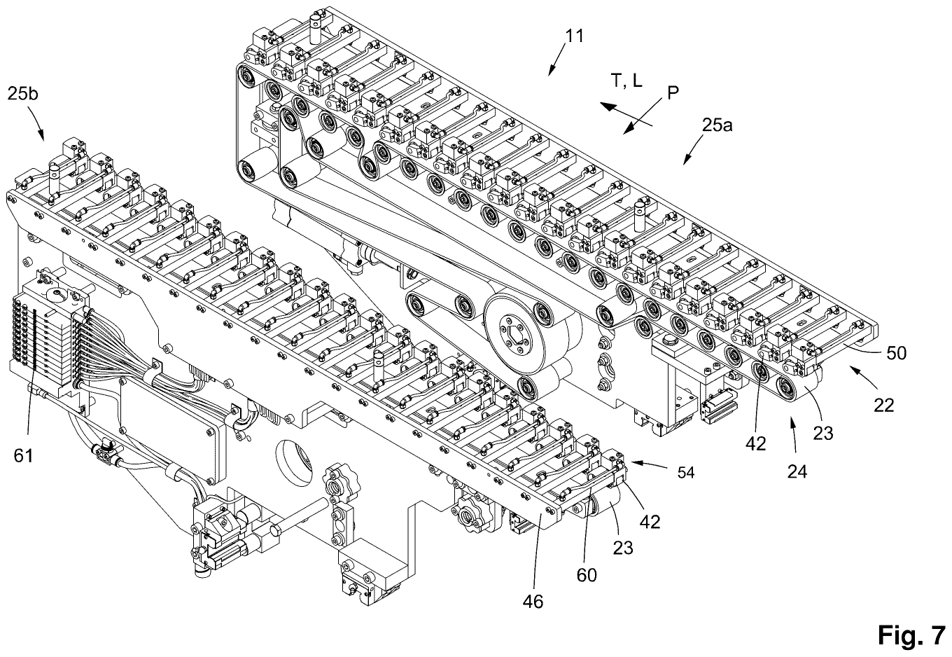

As illustrated in FIG. 7, the converting machine 1 preferably comprises a first alignment device 25a and a second alignment device 25b. The first alignment device 25a is configured to abut against a left side L of the blank 2 and the second alignment device 25b is configured to abut against a right side R of the blank 2. However, the first and second alignment devices 25a, 25b are not used at the same time. Instead, they provide the option to select which lateral edge R, L of the blank 2 to align against the guide 26. Typically, a straight or a uniform lateral edge is more advantageous to align against the guide 26 than an irregular lateral edge.

When one alignment device is activated, the other one is deactivated. In the deactivated alignment device, the pressing rollers 42 may be moved upwards and away from the blank 2 such that the pressing rollers 42 of the deactivated alignment device are not in contact with the blank 2. Alternatively, the contact pressure of the pressing rollers 42 is set such that the pressing rollers 42 are in contact with the blank but 2 are not applying a force sufficient to modify the trajectory of the blank 2. The lower alignment conveyor 24 in the deactivated alignment device may also be moved into a position where it is straight in the direction of transportation T. The guide 26 is positioned in the activated alignment device 25a, 25b.

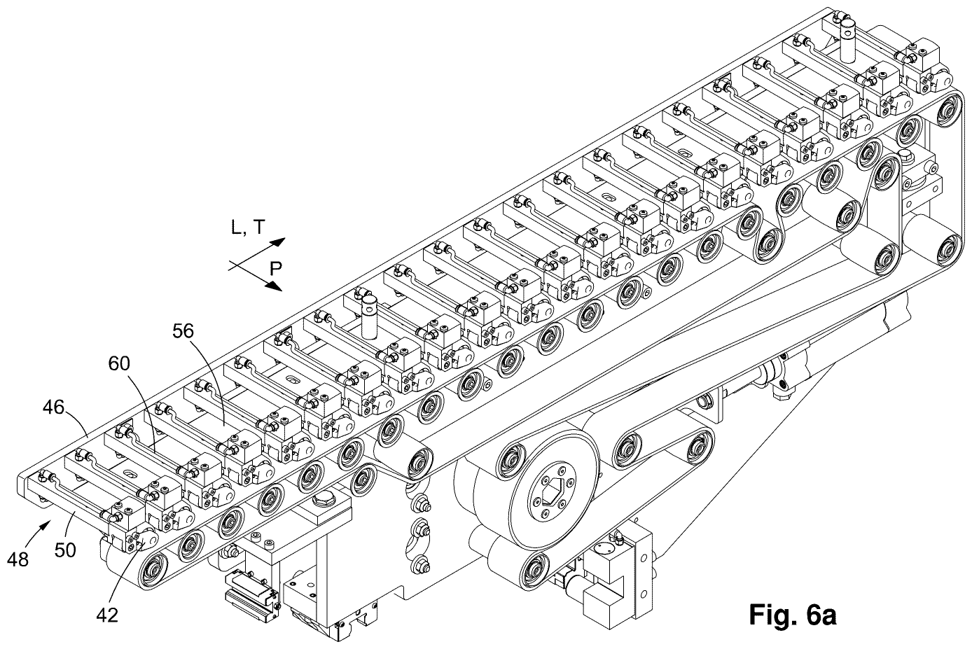

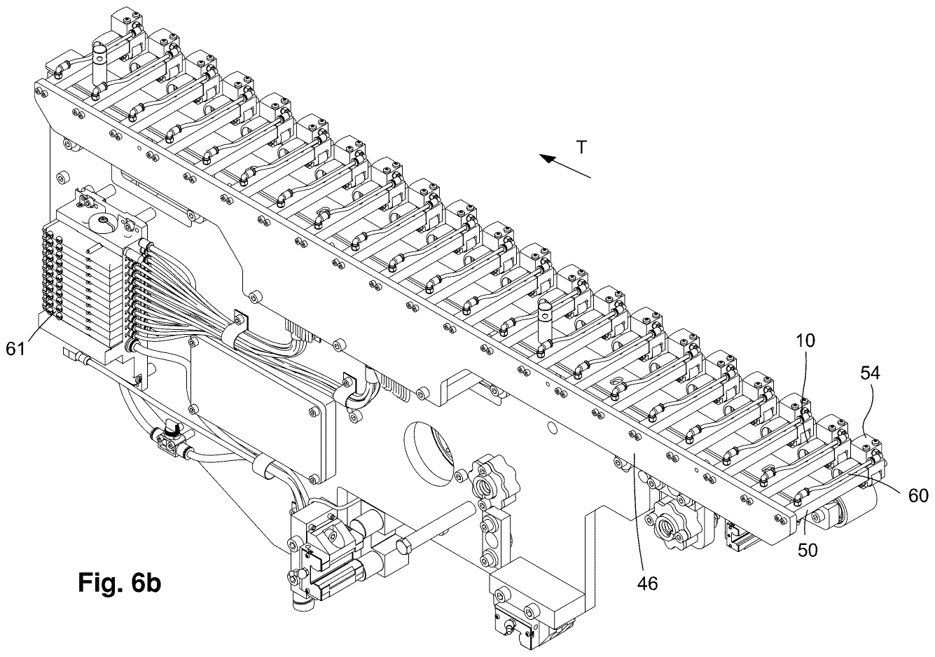

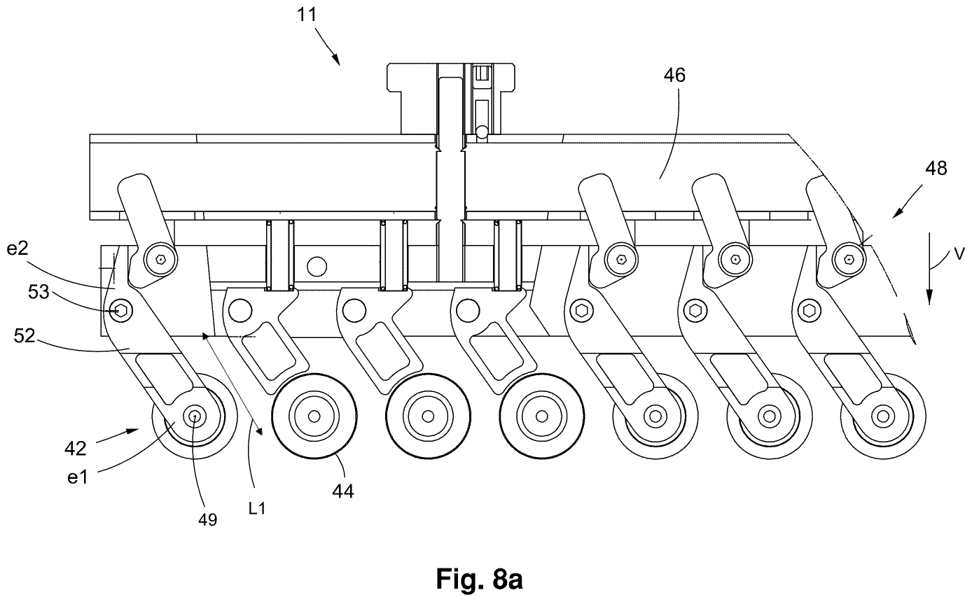

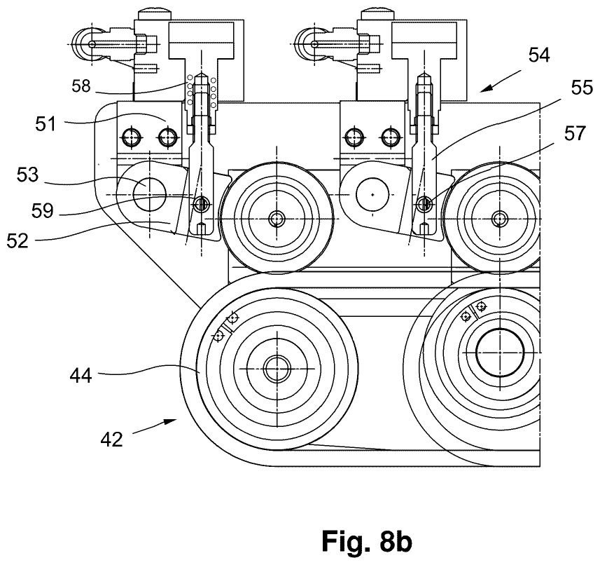

The pressing rollers 42 may be idle. As best seen in FIGS. 6a, 8a and 8b, the pressing rollers 42 are preferably provided with an elastic contact surface 44. For instance, the contact surface 44 may comprise rubber.

The pressing rollers 42 are attached to a linear frame member 46. A connection structure 48 is arranged between the pressing rollers 42 and the linear frame member 46. The connection structure comprises a plurality of cantilevered extensions 50, a vertical extension 51 (see FIG. 8b), a pivotable lever 52 and an actuator 54.

The plurality of cantilevered extensions 50 is attached to the linear frame member 46. The cantilevered extensions 50 extend in a direction perpendicular P to the longitudinal extension L of the linear frame member 46. The cantilevered extensions 50 thus extend parallel in relation to each other, and preferably in the horizontal direction.

As best seen in FIG. 8a, each pivotable lever 52 comprises a first distal end e1 onto which the pressing roller 42 is rotatably mounted. The second distal end e2 of the pivotable lever 52 is connected to the vertical extension 51 in a central pivot point 53.

As illustrated in FIG. 8b, the actuator 54 is provided with a displacement rod 55 having an extremity 57 connected to the pivotable lever 52. The pressing rollers 42 may be resiliently attached to the displacement rod 55. A spring member 58 is configured to bias the pressing rollers 42 away from the conveyor belt 23. Hence, the spring member 58 is biased such as to counteract the pressure applied by the actuator 54. The spring member 58 may be a compression spring 58 arranged around the displacement rod 55 of the actuator 54.

The displacement rod 55 of the actuator 54 is movable in a reciprocating way such that the contact pressure of the pressing rollers 42 can be adjusted by changing the fluidic pressure supplied to the actuator 54.

The actuator rod 55 is preferably arranged such that its longitudinal extension is coinciding with the vertical direction V. The extremity (i.e. free end) of the displacement rod 55 is connected to the pivotable lever 52 in a pivot point 59.

When the actuator rod 55 is extended, the pressing roller 42 performs a circular trajectory in relation to the central pivot point 53. The length L1 of the pivotable lever 52 from the 53 to the axis of the roller is selected such as to provide a vertical displacement component which is larger than a horizontal displacement. The length L1 can be measured from the 53 to the rotational axis 49 of the pressing roller 42.

Each of the actuators 54 is connected to a separate fluidic circuit 60 (see FIG. 7). The fluidic pressure in each fluidic circuit 60 can be modified such that the displacement rod 55 moves and the contact pressure of each pressing roller 42 onto the blank is adjusted. This allows modifying the contact pressure of the pressing rollers 42 depending on the thickness and the compressibility of the blanks 2. The fluidic circuit 60 is preferably individually operable for each pressing roller 42. The fluidic circuit 60 is preferably a pneumatic circuit. However, a hydraulic circuit 60 is also possible. A central valve 61 can be fluidically connected to each fluidic circuit 60 and configured to distribute an air supply to each actuator 54.

Preferably, the fluidic pressure in each fluidic circuit 60 can be individually modified such that the pressing rollers 42 are either be activated or deactivated. Activated means that the pressing roller 42 is applying pressure against the blank 2. Deactivated means that the pressing roller 42 is not applying pressure on the blank 2, and such that there is preferably no contact between the deactivated pressing roller 42 and the blank 2. Preferably, that the fluidic pressure in the inlet section I is the same for all pressing rollers 42 located in the inlet section I. Hence, the pressure in the applied by the pressing rollers 42 in the inlet section I may be zero. The fluidic pressure in the activated pressing rollers 42 may be the same for all pressing rollers 42 located in the guided section G.

The actuators 54 are automatically operable based on instructions from the control unit 32. The instructions may be entered manually into the user interface 13. However, it is advantageous that the instructions are provided by calculated settings provided by the control unit 32. Such a calculation may be based on a plurality of calibration parameters.

The converting machine 1 is calibrated each time the blank dimensions change. The calibration parameters include the blank thickness b1. Preferably, the calibration parameters also include the longitudinal length Lb of the blank. The material characteristics such as elastic deformation characteristics linked to material density may also be selected as a calibration parameter.

Sometimes, the type of blanks 2 to be processed are reoccurring from time to time and a stored set of configuration parameters can be selected from the operator interface 13 and retrieved from the memory 34. The control unit 32 may detect an identical job code or identifier and automatically displace the actuators 54.

These calibration parameters are entered into the central control circuitry 20 of the converting machine 1. The calibration parameters may be included in a data set which is contained in a processing file. Such a data set may either be physically, remotely or manually entered into the central control circuitry 20 of the converting machine 1. A physical entry includes entering a piece of hardware such as a data cable or a flash-drive or like into a communication port of the converting machine 1. A remote entering may be performed from a remote computing location connected to the central control circuitry 20 in a network architecture, such as a cloud network.

The side of alignment is selected based on the geometries of the lateral edges L, R of the blank 2. This can be selected manually by the operator. Alternatively, the control unit 32 may perform a calculation to determine which lateral side is most suitable for alignment.

The control unit 32 is configured to selectively activate a first alignment device 25a or a second alignment device 25b by moving the pressing rollers 42 of the disabled alignment device at a distance from the blank 2. In such a way, the pressing rollers 42 of the disabled upper pressing member 22 are not in contact with the blank 2. Alternatively, the pressing rollers 42 are in contact with the blank 2, but the pressure applied by the pressing rollers 42 is set to allow the blank 2 to move laterally.

The memory 34 comprises a program with an algorithm allowing the control unit 32 to calculate the required contact pressure from each pressing roller 42. The algorithm uses the calibration parameters to perform the calculation.

Based on the longitudinal length Lb of the blank 2, the control unit 32 may further determine the longitudinal length Li of the inlet section I and determine which pressing rollers 42 should be deactivated and moved apart from the blank 2.

1. An alignment module for lateral alignment of blanks in a converting machine, the alignment module comprising:
a first alignment device comprising:
an upper pressing member provided with a plurality of pressing rollers,
a lower alignment conveyor comprising a motorized alignment conveyor belt, and
a guide,
wherein the alignment module is configured to receive the blank between the upper pressing member and the lower alignment conveyor and convey the blank against the guide,
wherein the upper pressing rollers are connected to a linear frame member,
wherein at least some of the pressing rollers are connected to a respective actuator, said actuator being configured to displace the pressing roller in the vertical direction, and
wherein the alignment module further comprises a control unit and a memory, wherein the control unit is configured to determine a required displacement for each pressing roller and actuate each respective actuator to perform the required displacement.

2. The alignment module according to claim 1, wherein all pressing rollers are connected to a respective actuator and are all configured to be vertically displaced by said respective actuator.

3. The alignment module according to claim 1, wherein the control unit is configured to calculate a required contact pressure for each pressing roller and to displace the respective actuator to automatically perform the required displacement of each pressing roller.

4. The alignment module according to claim 1,
wherein the control unit is configured to divide the pressing rollers into a first group and a second group, and
wherein the pressing rollers in each group are provided with the same displacement and the displacement is different for the first and second group.

5. The alignment module according to claim 4, where the pressing rollers in the first group are distanced away from the blank and the pressing rollers in the second group are applying a pressure against the blank.

6. The alignment module according to claim 5, further comprising:
an inlet section provided in an upstream part of the alignment module,
wherein the pressing rollers in the inlet section are distanced away from the blanks such that they are not in contact with the blank, while the remaining pressing rollers are in contact with the blank.

7. The alignment module according to claim 6, wherein the control unit is further configured to adjust the length of the inlet section by determining the longitudinal length of the blank in the direction of transportation and move the pressing rollers in the inlet section such that they are distanced away from the blank.

8. The alignment module according to claim 1, further comprising:
a connection structure arranged between the pressing rollers and the linear frame member, the connection structure including a plurality of cantilevered extensions and a pivot lever, wherein each pivot lever is interconnecting a pressing roller to the cantilevered extension.

9. The alignment module according to claim 8,
wherein the connection structure further comprises a vertical extension to the cantilevered extension,
wherein the pivot lever has a first end connected to the vertical extension and a second end connected to the pressing roller, and
wherein the actuator comprises a displacement rod connected to the pivot lever in a pivot point located on the pivot lever.

10. The alignment module according to claim 9, wherein the cantilevered extensions extend in a direction perpendicular to the linear frame member.

11. The alignment module according to claim 1, wherein the actuator is a pneumatic actuator and is connected to a pneumatic circuit.

12. The alignment module according to claim 11, wherein each actuator is connected to a separate pneumatic circuit and wherein a central valve is configured to distribute the air supply to each pneumatic circuit.

13. The alignment module according to claim 1, wherein the control unit is configured to calculate the required displacement for the pressing rollers from the thickness of the blank.

14. The alignment module according to claim 13, wherein the control unit is configured to further calculate the required displacement for the pressing rollers from the longitudinal length of the blank.

15. The alignment module according to claim 1, further comprising:
a second alignment device,
wherein the control unit is configured to deactivate one of the first alignment device and the second alignment device by moving all pressing rollers of the deactivated alignment device into a clearing position in which they are not in contact with the blank.

16. The alignment module according to claim 1, wherein the vertical position of the pressing roller can be adjusted from a control interface.

17. The alignment module according to claim 1, wherein the memory is configured to store an inlet section length and contact pressure and make them retrievable from a user interface.
